(19) United States
(12) Patent Application Publication
(10) Pub. No.: US 2024/0402687 A1
(43) Pub. Date: Dec. 5, 2024

(54) CONTROLLING SYSTEM

(71) Applicants: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(72) Inventor: Michiaki MAJIMA, Fuchu Tokyo (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(21) Appl. No.: 18/804,409

(22) Filed: Aug. 14, 2024

Related U.S. Application Data
(63) Continuation of application No. PCT/JP2023/002393, filed on Jan. 26, 2023.

(30) Foreign Application Priority Data
Mar. 18, 2022 (JP) 2022-044548

(51) Int. Cl. G05B 19/418

(52) U.S. Cl. CPC G05B 19/4185; G05B 19/4184

(57) ABSTRACT

A controlling system includes a network line that communicably connects two controllers to each other. A controlling unit of a first controller executes a packet generating process in which a single packet that begins to be repeatedly transmitted at a first cycle is generated from first data and second data is divided to generate a plurality of packets that begin to be transmitted at a second cycle, and a packet transmitting process in which the single packet and the plurality of packets are transmitted to a second controller via the network line. In the packet transmitting process, the single packet is transmitted in preference to the plurality of packets, and a size of each of the plurality of packets is determined based on the first cycle and a transfer rate of the network line.

### CROSS REFERENCE TO RELATED APPLICATIONS

This application is a Continuation of International Application No. PCT/JP2023/002393, filed on Jan. 26, 2023 which claims the benefit of priority from the prior Japanese Patent Application No. 2022-044548, filed on Mar. 18, 2022, the entire contents of which are incorporated herein by reference.

### FIELD

The present disclosure relates to a controlling system, and in particular to a controlling system having a duplicate configuration including two controllers.

### BACKGROUND

Conventionally, in a controlling system of an industrial plant or the like, a configuration in which the controller is duplicated is known in order to avoid transient failures. In order to duplicate the controller, it is necessary to transmit the ever-changing data of the controller in the operating state (online side) to the controller in the standby state (standby side) to equalize the data of both. Both monitor the state of each other's station, and if an abnormality has occurred on the online side, the standby side is immediately promoted to online and continues operation.

However, when the controller is duplicated in conventional techniques, it is necessary to build dedicated hardware in order to transmit data from one controller to the other. Further, when data is transmitted using an existing network line such as Ethernet without building dedicated hardware, there is a problem that when there are a plurality of data having different priorities, it is difficult to efficiently transmit them.

### BRIEF DESCRIPTION OF THE DRAWINGS

FIG. 1 is a diagram showing a configuration of a controlling system according to a first embodiment.

FIG. 2 is a flowchart explaining a packet generating process according to the first embodiment.

FIG. 3 is a diagram showing a data flow according to the first embodiment.

FIG. 4 is a flowchart explaining a packet transmitting process according to the first embodiment.

FIG. 5 is a timing chart showing an example of a packet flow according to the first embodiment.

FIG. 6 is a timing chart showing an example of a packet flow according to a conventional technique.

FIG. 7 is a timing chart showing an example of a packet flow according to a variant of the first embodiment.

FIG. 8 is a timing chart showing an example of a packet flow according to another variant of the first embodiment.

### DETAILED DESCRIPTION

The present disclosure is to solve problems as described in the background, and aims to provide a controlling system that can efficiently transmit data having different priorities when transmitting data from one controller to the other in a controlling system having a duplicate configuration.

In order to solve the problems, a controlling system of the present disclosure comprises a first controller implemented by first circuitry; a second controller implemented by second circuitry; and a network line (or a communication network) that communicably connects the first controller and the second controller to each other, wherein a controlling unit of the first controller executes a packet generating process in which a single packet that begins to be repeatedly transmitted at a first cycle is generated from first data and second data is divided to generate a plurality of packets that begin to be transmitted at a second cycle, and a packet transmitting process in which the single packet and the plurality of packets are transmitted to the second controller via the network line, in the packet transmitting process, the single packet is transmitted in preference to the plurality of packets, and a size of each of the plurality of packets is determined based on the first cycle and a transfer rate of the network line.

Embodiments of the present disclosure will be described below with reference to the drawings. Note that the following description will be given based on an example in which a controlling system according to the present disclosure is used for the control of an industrial plant. However, the applicable range of the controlling system according to the present disclosure is not limited to the control of an industrial plant. Further, the same or corresponding elements in the drawings are given the same reference numeral, and detailed descriptions thereof are omitted as appropriate.

### First Embodiment

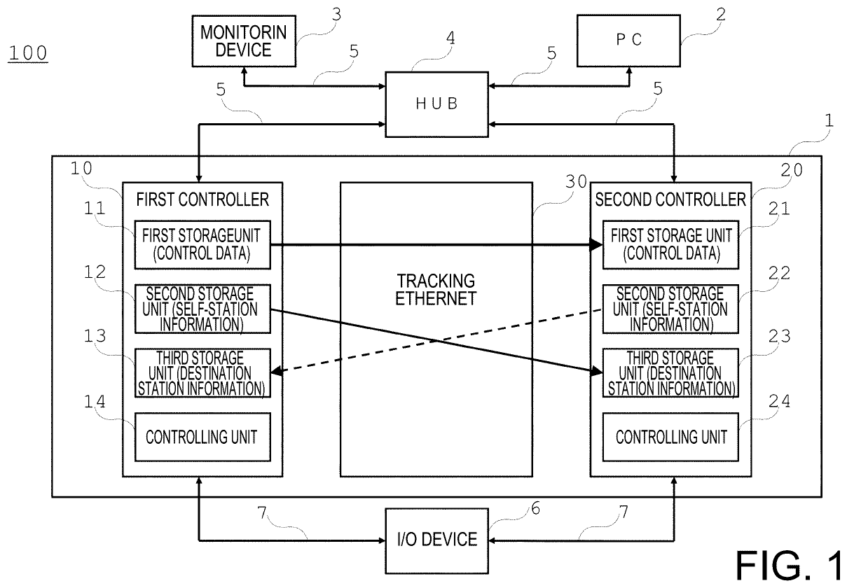

FIG. 1 is a diagram illustrating a configuration of a controlling system 100 of an industrial plant according to a first embodiment of the present disclosure. The controlling system 100 includes a controller 1, a personal computer (PC) 2, a monitoring device 3, a monitoring Ethernet 5 including an Ethernet hub (HUB) 4, and an I/O network 7 including an I/O device 6.

The controller 1 is an industrial controller such as a DCS (Distributed Control System) or a PLC (Programmable Logic Controller). The controller 1 collects states of the industrial plant based on signals received from sensors or the like not shown attached to the control target via the I/O device 6 and the I/O network 7. The controller 1 executes various calculations based on the collected states of the plant, and controls the industrial plant by operating actuators or the like not shown attached to the control target via the I/O network 7 and the I/O device 6 based on the calculation results.

The PC 2 is an information processing device provided with an engineering tool. The engineering tool is a program that manages the controller 1, for example, generates an application program executed by the controller 1, transmits the generated application program to the controller 1, monitors processes executed by the controller 1, etc. The monitoring device 3 is a computer for an operator to monitor the state of the industrial plant. The HUB 4 is a well-known network equipment for relaying packets flowing on the monitoring Ethernet 5.

The I/O device 6 is a device for receiving input of signals from or outputting signals to various devices attached to the control target. The I/O device 6 includes an AI (Analog Input) device, a DI (Digital Input) device, or the like to which a signal from a sensor or the like attached to the control target is input. Further, the I/O device 6 includes an AO (Analog Output) device, a DO (Digital Output) device, or the like that outputs a signal to an actuator or the like attached to the control target.

The controller 1 according to the first embodiment has a duplicate configuration including a first controller 10 and a second controller 20 having the same configuration. As described before, in order to duplicate the controller, it is necessary to transmit the ever-changing data of the controller in the operating state (online side) to the controller in the standby state (standby side) to equalize the data of both. Both monitor the state of each other's station, and if an abnormality has occurred on the online side, the standby side is immediately promoted to online and continues operation.

In the first embodiment, usually, the first controller 10 is in the operating state and the second controller 20 is in the standby state. Therefore, the following description will be given assuming that the first controller is in the operating state and the second controller 20 is in the standby state. When the first controller 10 is in the standby state and the second controller 20 is in the operating state, the relationship between the two in the following description is swapped.

The first controller 10 includes a first storage unit 11 that stores “control data” for the industrial plant, a second storage unit 12 that stores “self-station information” representing the operating state of the first controller 10 that is its self-station, and a third storage unit 13 that stores “destination station information” representing the operating state of the second controller 20 that is the destination station, and a controlling unit 14 that controls the operation of its self-station.

The second controller 20 includes a first storage unit 21 that stores “control data” for the industrial plant, a second storage unit 22 that stores “self-station information” representing the operating state of the second controller 20 that is its self-station, and a third storage unit 23 that stores “destination station information” representing the operating state of the first controller 10 that is the destination station, and a controlling unit 24 that controls the operation of its self-station.

The first controller 10 and the second controller 20 are communicatively connected to each other via a tracking Ethernet 30. The controlling unit 14 of the first controller 10 transmits the control data stored in the first storage unit 11 of its self-station to the second controller 20 via the tracking Ethernet 30. The controlling unit 24 of the second controller 20 that has received this updates the control data stored in the first storage unit 21 of its self-station with the received control data.

Further, the controlling unit 14 of the first controller 10 transmits the self-station information stored in the second storage unit 12 of its self-station to the second controller 20 via the tracking Ethernet 30. The controlling unit 24 of the second controller 20 that has received this updates the destination station information stored in the third storage unit 23 of its self-station with the received information.

Similarly, the controlling unit 24 of the second controller 20 transmits the self-station information stored in the second storage unit 22 of its self-station to the first controller 10 via the tracking Ethernet 30. The controlling unit 14 of the first controller that has received this updates the destination station information stored in the third storage unit 13 of its self-station with the received information.

Next, a process in transmitting the control data from the first controller 10 to the second controller 20 in the controlling system 100 according to the first embodiment will be described in detail.

The controlling unit 14 of the first controller 10 repeatedly executes two tasks, a high-speed scan task and a standard scan task, each at a predetermined cycle. Specifically, the high-speed scan task and the standard scan task are tasks that operate on a real-time OS executed by the controlling unit 14, and both apparently operate in parallel.

The high-speed scan task is repeatedly executed at a first cycle “T1”. In the high-speed scan task, only particularly important data that is predetermined among the control data stored in the first storage unit 11 is scanned, and high-speed scan data of a first size “S1” is created. The standard scan task is repeatedly executed at a second cycle “T2”. In the standard scan task, all the control data stored in the first storage unit 11 is scanned, and standard scan data of a second size “S2” is created.

In the first embodiment, the first cycle “T1” of the high-speed scan task is shorter than the second cycle “T2” of the standard scan task, that is, T1<T2. Further, the first size “S1” of the high-speed scan data is smaller than the second size “S2” of the standard scan data, that is, S1<S2. Further, when transmitted via the tracking Ethernet 30, the high-speed scan data is transmitted as high-priority data, and the standard scan data is transmitted as low-priority data.

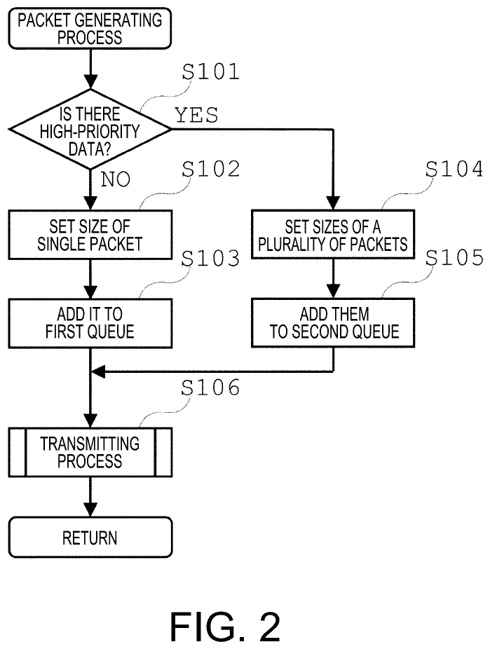

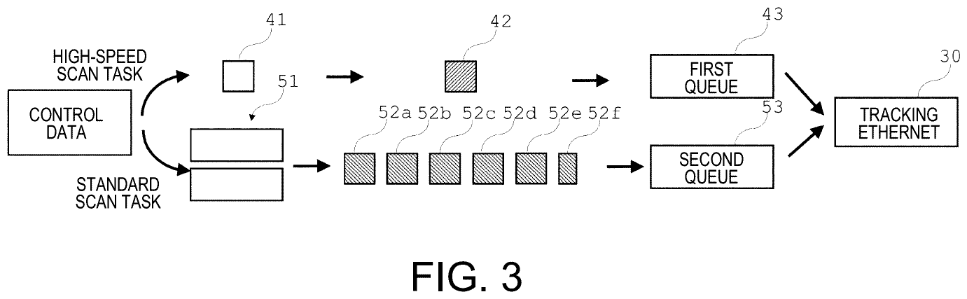

Upon completion of each of the high-speed scan task and the standard scan task, the controlling unit 14 of the first controller 10 executes a packet generating process shown in the flowchart of FIG. 2. In the packet generating process, a single packet is generated from the high-priority high-speed scan data, and a plurality of packets are generated by dividing the low-priority standard scan data. In the following description, as an example, six packets are generated by dividing the standard scan data, but the number of generated packets varies depending on the size of the standard scan data and the like. In the following description, the data flow shown in FIG. 3 should also be referenced.

In step S101 of FIG. 2, the controlling unit 14 determines whether or not there is scan data having a higher priority than the scan data currently being processed. Specifically, when the scan data currently being processed is high-speed scan data 41, there is no scan data having a higher priority than that, so the processing flow proceeds to NO. On the other hand, when the scan data currently being processed is standard scan data 51, there is scan data having a higher priority than that, that is, high-speed scan data 41, so the processing flow proceeds to YES.

In step 102, the controlling unit 14 sets the size of a single packet 42 generated from the high-priority high-speed scan data 41. Specifically, the size of the single packet 42 is set to be equal to the first size “S1” of the high-speed scan data 41. In the case of the tracking Ethernet 30, such a setting can be made by using a jumbo frame.

In step S103, the controlling unit 14 adds the single packet 42 generated in the above step S102 to the tail of a first queue 43. The first queue 43 is a queue having a higher priority than a second queue 53 described next.

On the other hand, in step S104, the controlling unit 14 sets the respective sizes of a plurality of packets 52a-52f generated by dividing the low-priority standard scan data 51. Specifically, except for the last packet 52f, the respective sizes of the plurality of packets 52a-52e are all equal and set according to the following equation (1).

$$Δ S = ( T 1 / N ) * R \qquad ( 1 )$$

Here, in the above equation, “ΔS” is the size of each of the plurality of packets 52a-52e, “T1” is the first cycle of the high-speed scan task, “N” is a predetermined positive number, and “R” is the transmission rate of the tracking Ethernet 30. Further, the size of the last packet 52f is smaller than “ΔS” mentioned above.

The above equation (1) means the size of data that can be transmitted via the tracking Ethernet 30 in a time of 1/N of the first cycle “T1” of the high-speed scan task. For example, when the first cycle “T1” of the high-speed scan task=1 second, the predetermined positive number N=10, and the transmission rate R of the tracking Ethernet 30=1 Gbps, the size “ΔS” of each of the plurality of packets 52a-52e is set to ΔS=12 Mbytes. From the definition of the equation (1), the time required to transmit one packet of the plurality of packets 52a-52e excluding the last packet 52f is 1/10=0.1 seconds. Further, the time required to transmit the last packet 52f is shorter than 0.1 seconds.

In step S105, the controlling unit 14 adds the plurality of packets 52a-52f generated in the above step S104 to the second queue 53. The second queue 53 is a queue having a lower priority than the first queue 43 described above.

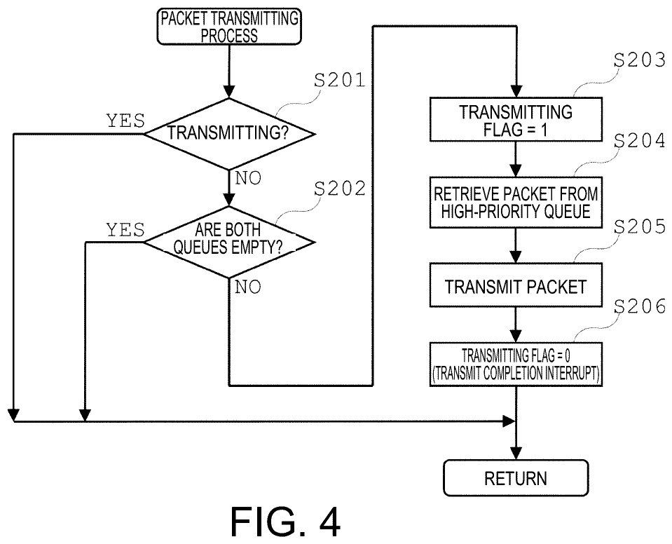

In step S105, the controlling unit 14 calls a packet transmitting process shown in the flowchart of FIG. 4.

The packet transmitting process shown in the flowchart of FIG. 4 is called from step S105 of the packet generating process of FIG. 2, or from the transmission completion interrupt in step S205 of the packet transmitting process of FIG. 4.

In step S201 of FIG. 4, the controlling unit 14 of the first controller 10 determines whether or not the packet transmitting process is being executed. Specifically, when the value of the transmitting flag is 1, it is determined that the packet transmitting process is being executed (S201=YES). In this case, the processing flow proceeds to “RETURN”, and the packet transmitting process of FIG. 4 ends. On the other hand, when the value of the transmitting flag is 0, it is determined that the packet transmitting process is not being executed (S201=NO). In this case, the processing flow proceeds to step S202.

In step S202, the controlling unit 14 determines whether or not the first queue 43 and the second queue 53 are both empty. Specifically, if both the first queue 43 and the second queue 53 are empty (S202=YES), the processing flow proceeds to “RETURN”, and the packet transmitting process of FIG. 4 ends. On the other hand, if a packet is contained in either or both of the first queue 43 and the second queue 53 (S202=NO), the processing flow proceeds to step S203.

In step S203, the controlling unit 14 sets the value of the transmitting flag to 1. In step S204, the controlling unit 14 retrieves one packet from the head of the high-priority queue. Specifically, when a packet is contained in the first queue 43, the controlling unit 14 retrieves one packet 42 from the head of the first queue 43. On the other hand, when the first queue 43 is empty, the controlling unit 14 retrieves one of the packets 52a-52f from the head of the second queue 53.

In step S205, the controlling unit 14 transmits the one packet retrieved in the above step S204 to the second controller 20 via the tracking Ethernet 30. In step S206, the controlling unit 24 sets the value of the transmitting flag to 0, and generates a transmission completion interrupt.

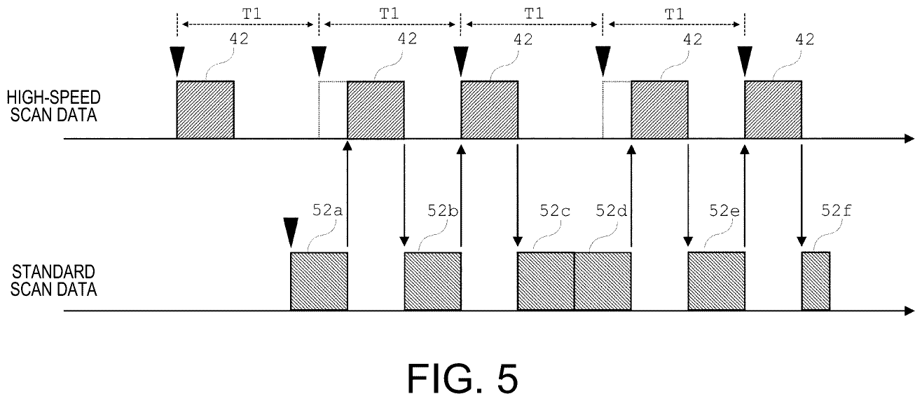

The flow of packets transmitted from the first controller 10 to the second controller 20 when the processes of FIGS. 2 and 4 are performed is as shown in the timing chart of FIG. 5. In vacant times between repeated transmissions of the single packet 42 generated from the high-priority high-speed scan data 41 at the first cycle “T1”, the plurality of packets 52a-52f generated by dividing the low-priority standard scan data 51 are transmitted. Note that the downward triangles in FIG. 5 indicate the timing at which packet transmission is started.

In FIG. 5, even if the timing of transmitting the single packet 42 generated from the high-priority high-speed scan data 41 has come during the transmission of one packet 52a of the plurality of packets 52a-52f generated from the low-priority standard scan data 51, once the transmission of the one packet 52a with low priority currently being transmitted has been completed, the transmission of the single packet 42 with high priority is started immediately. Thus, the delay time until the start of transmission of the single packet 42 generated from the high-priority high-speed scan data 41 is always shorter than the time required for transmission of one packet of the plurality of packets 52a-52f generated from the low-priority standard scan data 51. Therefore, it is possible to simultaneously transmit the plurality of packets 52a-52f generated from the low-priority standard scan data 51 while suppressing the transmission delay of the single packet 42 generated from the high-priority high-speed scan data 41 as much as possible.

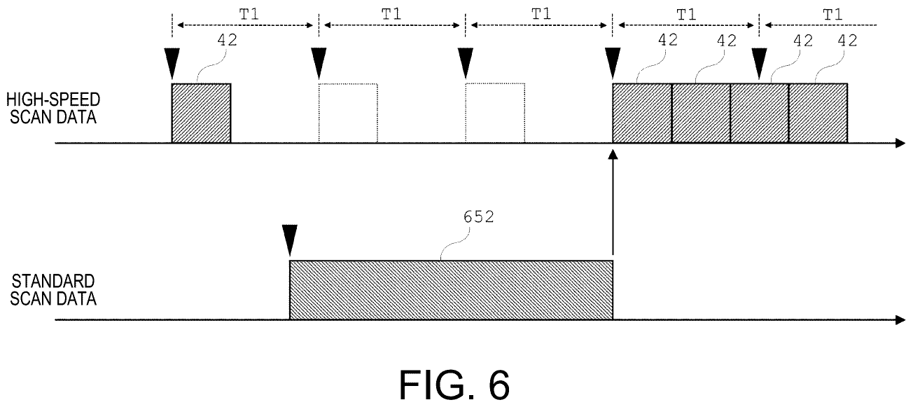

FIG. 6 is a timing chart showing an example of a flow of packets transmitted from the first controller 10 to the second controller 20 when transmitting the low-priority standard scan data 51 with a single packet 652 without division as in the first embodiment. In this case, even if the timing of transmitting the single packet 42 generated from the high-priority high-speed scan data 41 has come during the transmission of a single packet 652 generated from the low-priority standard scan data 51, the transmission of the single packet 42 is started after the transmission of the packet 652 has been completed. Therefore, the transmission delay of the single packet 42 generated from the high-priority high-speed scan data 41 increases.

As described above, the controlling unit 14 of the first controller 10 according to the first embodiment generates, from the high-speed scan data 41, the single packet 42 that begins to be repeatedly transmitted at the first cycle, divides the standard scan data 51 to generate the plurality of packets 52a-52f that begin to be repeatedly transmitted at the second cycle, and transmits the single packet 42 and the plurality of packets 52a-52f to the second controller 20 via the tracking Ethernet 30.

At this time, the single packet 42 generated from the high-priority high-speed scan data 41 is transmitted in preference to the plurality of packets 52a-52f generated from the low-priority standard scan data 51, and the size of each of the plurality of packets 52a-52f is determined based on the first cycle “T1” and the transmission rate R of the tracking Ethernet 30.

The above features enable the controlling system 100 according to the first embodiment to simultaneously transmit low-priority data while suppressing the transmission delay of high-priority data when transmitting data from the first controller 10 to the second controller 20. Therefore, in the controlling system 100 according to the first embodiment, it is possible to efficiently transmit data of different priorities when transmitting data from one controller to the other.

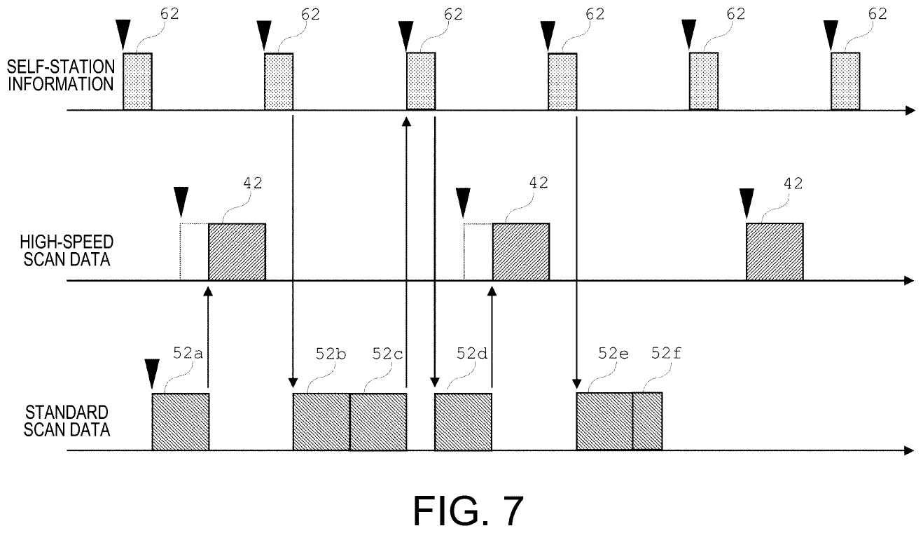

Note that in the first embodiment, an example of transmitting the high-speed scan data as high-priority data and transmitting the standard scan data as low-priority data has been shown, but there may be two or more types of high-priority data. FIG. 7 is a timing chart when the self-station information and the high-speed scan data are transmitted as high-priority data and the standard scan data is transmitted as low-priority data. In vacant times between repeated transmissions of a single packet 62 generated from the self-station information of high priority and the single packet 42 generated from the high-speed scan data again of high priority, the plurality of packets 52a-52f generated by dividing the low-priority standard scan data are transmitted.

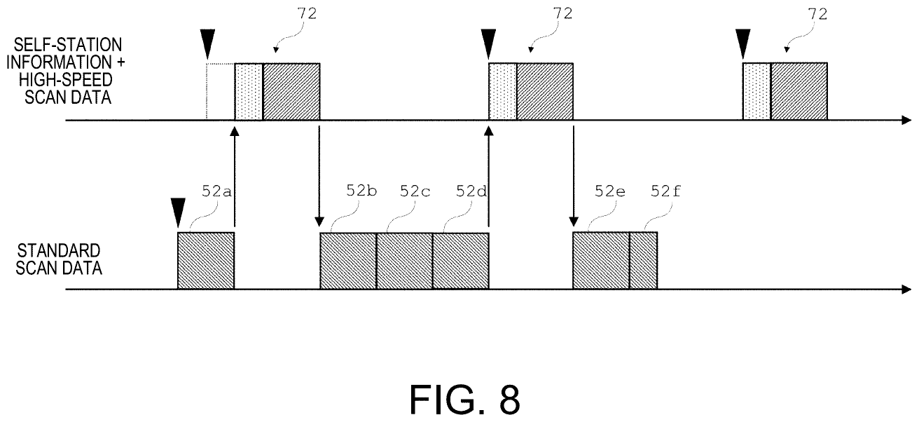

Further, the high-priority data may include two or more types of data. FIG. 8 is a timing chart when the self-station information and the high-speed scan data are transmitted as high-priority data and the standard scan data is transmitted as low-priority data. In vacant times between repeated transmissions of a single packet 72 generated from data obtained by combining the high-priority self-station information and high-speed scan data, the plurality of packets 52a-52f generated by dividing the low-priority standard scan data are transmitted.

Further, in the first embodiment described above, a process for determining in advance whether or not packet congestion occurs in the tracking Ethernet 30 may be added. Specifically, prior to the execution of the processes of FIGS. 2 and 4, the controlling unit 14 of the first controller 10 determines whether or not the following two conditions are satisfied.

$$\begin{matrix}( T 1 - E 1 ) > S 1 / R \\ ( T 2 - E 1 ) - ( T 2 - E 2 ) / T 1 * ( S 1 / R ) > S 2 / R\end{matrix}$$

Here, in the above equation, “T1” is the cycle of the high-speed scan task, “E1” is the execution time of the high-speed scan task, “S1” is the size of the high-speed scan data, “T2” is the cycle of the standard scan task, “E2” is the execution time of the standard scan task, “S2” is the size of the standard scan data, and “R” is the transmission rate of the tracking Ethernet 30. Further, the execution time “E2” of the standard scan task includes the time of interruption by the high-speed scan task.

When the above two conditions are satisfied, packet congestion does not occur in the tracking Ethernet 30. On the other hand, when the above two conditions are not satisfied, packet congestion occurs in the tracking Ethernet 30. In this case, the controlling unit 14 of the first controller 10 can warn the operator that the duplexing does not operate correctly.

In the embodiment, each storage unit in FIG. 1 includes, for example, a storage medium such as an HDD, a SSD, a memory apparatus, CD-R, CD-RW, DVD-RAM, or DVD-R, and the like. Also, the monitoring device 3, I/O device 6, the first controller 10, the controlling unit 14, or the second controller 20 are implemented by circuitry such as FPGA (Field Programable Gate CPU (Central Array), Processing Unit) or ΔSIC (Application Specified Integrated Circuit), or a processor. A computer program which causes the CPU or the processor to processes in FIG. 2 or FIG. 4 may be installed in the controller 1, and the CPU or the processor executes the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A controlling system comprising:
a first controller;
a second controller; and
a network line that communicably connects the first controller and the second controller to each other,
wherein a controlling unit of the first controller executes
a packet generating process in which a single packet that begins to be repeatedly transmitted at a first cycle is generated from first data and second data is divided to generate a plurality of packets that begin to be transmitted at a second cycle, and
a packet transmitting process in which the single packet and the plurality of packets are transmitted to the second controller via the network line,
in the packet transmitting process, the single packet is transmitted in preference to the plurality of packets, and
a size of each of the plurality of packets is determined based on the first cycle and a transfer rate of the network line.

2. The controlling system according to claim 1, wherein
the size of each of the plurality of packets except for a last packet is determined according to the following equation:
$$Δ S = ( T 1 / N ) * R ,$$
where in the above equation, “ΔS” is the size of each of the plurality of packets, “T1” is the first cycle, “N” is a predetermined positive number, and “R” is the transfer rate of the network line.

3. The controlling system according to claim 1, wherein the first data includes two or more types of data.

4. The controlling system according to claim 2, wherein the first data includes two or more types of data.

5. The controlling system according to claim 1, wherein the first cycle is shorter than the second cycle.

6. The controlling system according to claim 2, wherein the first cycle is shorter than the second cycle.

7. The controlling system according to claim 3, wherein the first cycle is shorter than the second cycle.

8. The controlling system according to claim 1, wherein a size of the first data is smaller than a size of the second data.

9. The controlling system according to claim 2, wherein a size of the first data is smaller than a size of the second data.

10. The controlling system according to claim 3, wherein a size of the first data is smaller than a size of the second data.

11. The controlling system according to claim 4, wherein a size of the first data is smaller than a size of the second data.

12. The controlling system according to claim 2, wherein
prior to executing the packet generating process and the packet transmitting process, the controlling unit determines whether or not the following conditions are satisfied:
$$\begin{matrix}( T 1 - E 1 ) > S 1 / R , and \\ ( T 2 - E 1 ) - ( T 2 - E 2 ) / T 1 * ( S 1 / R ) > S 2 / R ,\end{matrix}$$
where in the above equation, “T1” is the first cycle, “E1” is a time required to generate the first data, “S1” is a size of the first data, “T2” is the second cycle, “E2” is a time required to generate the second data, “S2” is a size of the second data, and “R” is the transmission rate of the network line.
